(19) United States
(12) Patent Application Publication
(10) Pub. No.: US 2026/0194788 A1
(43) Pub. Date: Jul. 9, 2026

(54) WAVELENGTH CONVERSION RECEIVER

(71) Applicant: BAE Systems Space & Mission Systems Inc., Broomfield, CO (US)

(72) Inventors: Nicholas L. Wagner, Arvada, CO (US); Kevin L. Whiteaker, Berthoud, CO (US); James V. Rudd, Louisville, CO (US); Gabriel M. Murray, Littleton, CO (US); Piotr Konrad Kondratko, Broomfield, CO (US); Christopher R. Teti, Broomfield, CO (US)

(73) Assignee: BAE Systems Space & Mission Systems Inc., Broomfield, CO (US)

(21) Appl. No.: 19/430,675

(22) Filed: Dec. 23, 2025

Related U.S. Application Data
(60) Provisional application No. 63/742,095, filed on Jan. 6, 2025.

(51) Int. Cl. G02F 1/365; H04B 10/60

(52) U.S. Cl. CPC G02F 1/365; H04B 10/60

(57) ABSTRACT

Systems and methods for converting a wavelength of an optical signal are provided. An optical signal that includes light having at least a first frequency (wavelength) and a plurality of spatial and polarization modes is received at a receiver. This multimode optical signal is converted into a one or more optical signals having a single spatial mode and a single polarization mode by a mode converter. The at least one single mode optical signal is passed to at least one nonlinear optical frequency conversion module. The at least one nonlinear optical frequency conversion module changes the frequency of the received at least one single mode optical signal from an initial frequency to a converted frequency, where the converted frequency is higher than the initial frequency. The frequency converted light is then passed to a detector.

### CROSS-REFERENCE TO RELATED APPLICATION

This application claims the benefit of U.S. Provisional Patent Application Ser. No. 63/742,095, filed Jan. 6, 2025, the entire disclosure of which is hereby incorporated herein by reference.

### FIELD

The present disclosure is directed to systems and methods for converting a wavelength of a received signal and for delivering the wavelength converted signal to a detector. In at least some embodiments, systems and methods are disclosed that incorporate a mode converter and a nonlinear optical wavelength converter.

### BACKGROUND

Long range light or laser detection and ranging (LiDAR or LADAR) systems and nonconventional imaging systems involve the illumination of remote objects with a modulated optical beam and the analysis of the temporal characteristics of the back reflected signal to characterize various properties of an object, such as location, range, velocity, size, and surface type. Typical applications of this technology demand long detection ranges and limited size, weight, and power requirements. Similarly, free space laser communication systems require long detection ranges and can have limitations on transmitter power requirements. In order to meet these requirements, it is important to optimize the system transmit and receive wavelength for efficient optical source generation, atmospheric transmission, and detection. In addition, it is important to reduce system background noise to enable the detection of dim back reflections or signals, which requires optical sensors that are extremely sensitive, that have high temporal bandwidth, and that are matched to the wavelength of the available high power optical transmitters or lasers.

The use of relatively long wavelength signals can have various advantages in such systems. For instance, longer wavelengths can provide better penetration through atmospheric conditions such as fog, dust, and haze than shorter wavelengths, allowing for improved signal strength and detection at the receiver. In addition, in some wavebands, laser light sources operating at relatively long wavelengths can be more efficient than laser light sources operating at shorter wavelengths.

The most sensitive optical detectors are photon counting detectors, such as Geiger mode avalanche photodiode (GmAPD) or single-photon avalanche photodiode (SPAD) focal plane arrays, which are commercially available in visible, near infrared (NIR), and shortwave infrared (SWIR) spectral bands. These detectors also have very high temporal bandwidth (e.g. up to 4-10 GHz). However, in longer wavelength spectral bands, such as extended SWIR (e.g. 2.0-2.6 μm) and middle wavelength infrared (MWIR) (e.g. 3-5 μm), photon counting detectors are currently not available commercially. To the extent they exist, they are one-of-a-kind research grade detectors with significant disadvantages, such as requirements for cryogenic cooling, low detection efficiency, and high levels of dark noise. Accordingly, the ability to detect dim, long wavelength signals has been limited.

Systems and methods for shifting the wavelength of a signal are available. However, such systems and methods have been inefficient when applied to multimode signals. That is, such systems and methods have required a single mode signal in order to operate at acceptable levels of efficiency. However, after propagating over long ranges through the atmosphere, a signal of interest will typically suffer from the effects of system pointing jitter, atmospheric distortion, atmospheric scintillation, speckle, and platform vibration. As a result, the signal of interest will typically comprise a number of spatial and polarization modes when it arrives at a receiver.

Accordingly, there remains a need for systems and methods for receiving and detecting relatively low frequency (or long wavelength) multimode optical signals.

### SUMMARY

Embodiments of the present disclosure are directed to systems and methods for detecting relatively long wavelength, relatively low frequency, multimode optical signals. As used herein, optical signals can include electromagnetic waveforms or signals at wavelengths from the ultraviolet (i.e. from about 10 nanometers) to the medium wave infrared (MWIR) (i.e. to about 5 micrometers). In accordance with embodiments of the present disclosure, the optical signals are converted to single spatial and polarization mode, shorter wavelength, higher frequency optical signals, before they are passed to a detector. As a result of this conversion, optical signals that are received as multimode, relatively low frequency optical waveforms can be reliably and efficiently detected.

Systems in accordance with embodiments of the present disclosure generally include a receiver with a mode converter and one or more nonlinear frequency converters. The mode converter has a single input and a plurality of outputs. More particularly, the mode converter operates to convert a multimode electromagnetic optical signal incident on its input to a plurality of single spatial and polarization mode optical signals. In accordance with embodiments of the present disclosure, the mode converter does not alter a frequency of the received optical signal. Accordingly, the frequency of the multimode electromagnetic signal as received at the optical input of the mode converter is the same as the frequency of the single mode optical signals at the optical outputs of the mode converter. Each of the single mode optical signals is passed from an output of the mode converter to the inputs of a nonlinear optical frequency converter.

The nonlinear optical frequency converter includes at least one input for each of the outputs of the mode converter. In accordance with at least some embodiments of the present disclosure, the nonlinear optical frequency converter includes a plurality of single mode inputs and a plurality of outputs. In accordance with other embodiments of the present disclosure, a plurality of nonlinear optical frequency converters, each of which has one or more single mode inputs and one or more outputs, are provided. The one or more nonlinear optical frequency converters convert each of the optical signals received at the inputs thereof from relatively low frequency, long wavelength, single mode optical signals to a plurality of relatively high frequency, shorter wavelength optical signals. The relatively high frequency optical signals are then provided to a detector, which converts the relatively high frequency optical signals to electrical signals. The detector can include one or more multiple pixel detectors or one or more single pixel detectors. In accordance with at least some embodiments of the present disclosure, the outputs of the one or more nonlinear optical frequency converters are free space outputs.

Methods for detecting optical signals in accordance with embodiments of the present disclosure include receiving light that includes an optical signal having a first frequency. As received, the optical signal can include light having a plurality of spatial, polarization, or spatial and polarization modes. The collected light is separated by mode and placed onto a plurality of different optical fibers. More particularly, each optical fiber in the plurality of optical fibers includes single mode light obtained from the received light. In accordance with further embodiments of the present disclosure, each optical fiber in the plurality of optical fibers can include light having a different spatial mode and/or a different polarization mode from the light in any other optical fiber in the plurality of optical fibers. The single mode light carried by the optical fibers is then converted from the first frequency to a second frequency, where the second frequency is higher than the first frequency. The frequency converted light is then detected. In accordance with embodiments of the present disclosure, detecting the frequency converted light includes passing the frequency converted optical signals to one or more photodetectors, and converting the frequency converted optical signals to electrical signals. In accordance with further embodiments of the present disclosure, the first frequency is outside of the nominal intrinsic spectral band of the detector, while the second frequency is within the nominal intrinsic spectral band of the detector.

Additional features and advantages of embodiments of the disclosed systems and methods will become more readily apparent from the following description, particularly when taken together with the accompanying drawings.

### BRIEF DESCRIPTION OF THE DRAWINGS

FIG. 1A depicts an optical system with a receiver in accordance with embodiments of the present disclosure in an exemplary operating environment;

FIG. 1B depicts an optical system with a receiver in accordance with other embodiments of the present disclosure in an exemplary operating environment;

FIG. 2 is a block diagram depicting components of a receiver in accordance with embodiments of the present disclosure;

FIG. 3 is a block diagram depicting a mode converter of a receiver in accordance with embodiments of the present disclosure;

FIG. 4 is a block diagram depicting a nonlinear optical frequency converter of a receiver in accordance with embodiments of the present disclosure; and

FIG. 5 is a flowchart illustrating aspects of a method for converting multimode light having a first frequency to a second frequency in accordance with embodiments of the present disclosure.

### DETAILED DESCRIPTION

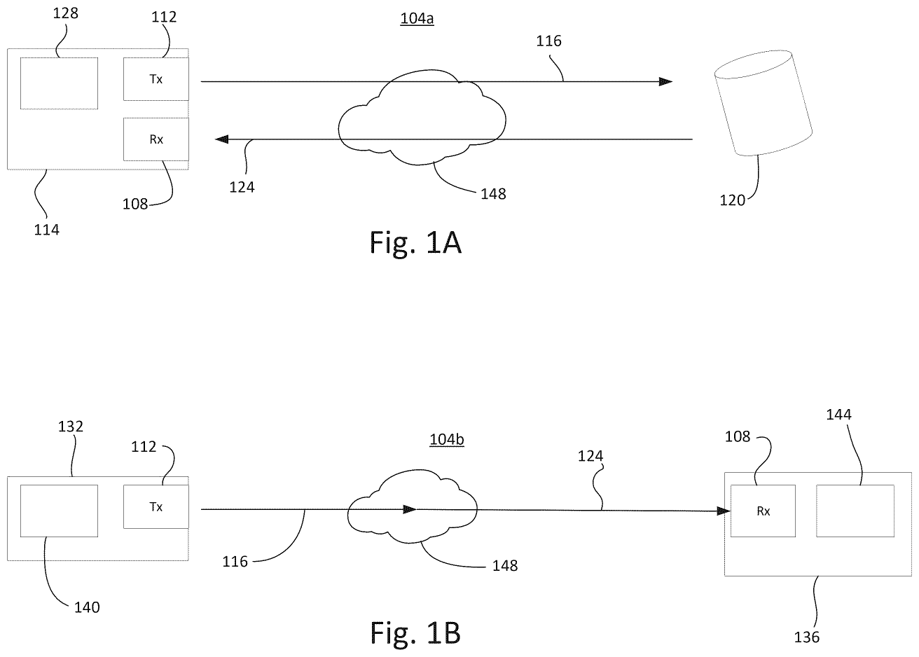

FIGS. 1A and 1B depict optical systems 104 incorporating a receiver 108 in accordance with embodiments of the present disclosure in exemplary operating environments. More particularly, FIG. 1A depicts a light detecting and ranging (LiDAR) or a laser detection and ranging (LADAR) system 104a (hereinafter referred to simply as a LADAR system 104a). In this example configuration, the LADAR system 104a includes a transmitter 112 and a receiver 108 that are co-located with one another as part of a LADAR instrument 114. In operation, the transmitter 112 of the LADAR system 104a emits a transmitted optical signal 116 that is passed through the atmosphere 148, and that is directed so as to illuminate a selected volume of the atmosphere or an object 120. A return or received optical signal 124, reflected from the volume of the atmosphere or object 120, passes back through the atmosphere 148, and is received at the receiver 108. The received optical signal 124 allows information about the volume of the atmosphere or the object 120, such as a location, range, velocity, size, surface type, and composition, to be determined. As can be appreciated by one of skill in the art after consideration of the present disclosure, the operation of the LADAR instrument 114 to emit a transmitted optical signal 116 and to determine information about a volume of the atmosphere or object 120 can be performed in conjunction with a LADAR control system 128, which in at least some embodiments is provided as an integral part of the LADAR instrument 114.

FIG. 1B depicts a free space optical communication system 104b that includes a transmitter 112 provided as part of a transmitting system 132, and a receiver 108 provided as part of a receiving system 136 that is spaced apart from the transmitting system 132. In operation, the transmitter 112 sends a transmitted optical signal 116 across free space, through the atmosphere 148. The transmitted optical signal 116 can be modulated to encode information. The transmitted optical signal 116 arrives at the receiver 108 as a received optical signal 124. As can be appreciated by one of skill in the art after consideration of the present disclosure, a transmitter control system 140 can be provided as part of or in conjunction with the transmitting system 132 to control operation of the transmitter 112, including operating the transmitter 112 to encode the transmitted optical signal 116 with information for delivery to the receiver 108. As can also be appreciated by one of skill in the art after consideration of the present disclosure, a receiver control system 144 can be provided as part of or in conjunction with the receiving system 136 to control operation of the receiver 108, including to transform the received optical signal 124 to a signal having a frequency within a nominal detection range of a detector and to retrieve information encoded in the received optical signal 124.

As can be appreciated by one of skill in the art after consideration of the present disclosure, there can be various advantages to operating a LADAR system 104a or a communication system 104b using relatively low frequency, long wavelength light (e.g., light having a wavelength longer than the detection band of widely available indium gallium arsenide detectors), particularly in applications involving long range propagation of the optical signals 116 and 124 through the atmosphere 148. However, detectors capable of operating to create an electrical output signal in response to receiving light at such long wavelengths have suffered from various limitations, such as low detection efficiencies, high levels of dark noise, requirements for cryogenic cooling, and high costs. In addition, a received optical signal 124 will typically suffer from attenuation and alteration due to various effects, such as but not limited to system pointing jitter, atmospheric distortion, speckle, and platform vibration. Moreover, even if the transmitted optical signal 116 initially has a single mode, it will typically acquire multiple modes before arriving at a receiver 108 as a received optical signal 124 as a result of passing through the atmosphere 148. Although it is possible to convert the frequency of a received optical signal 124 to a higher frequency, systems for doing so have heretofore been inefficient, particularly when used in connection with large system apertures and when used to detect light having multiple modes.

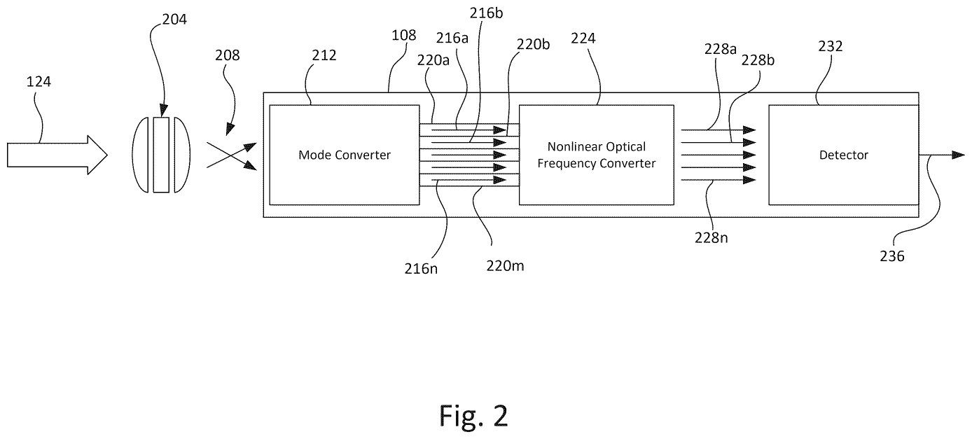

The present disclosure provides receivers 108 that enable the reliable and efficient detection of optical signals that are transmitted as relatively low frequency, long wavelength (e.g., 1.7 microns or longer) signals 116 and that arrive as received signals 124 that may have been altered or attenuated by the atmosphere 148 and that contain multiple polarization and/or spatial modes. With reference now to FIG. 2, a receiver 108 and associated components in accordance with embodiments of the present disclosure are depicted. More particularly, a lens system 204 collects and/or focuses the relatively long wavelength received light 124, forming collected light 208 that is directed to an input of a mode converter 212 of the receiver 108. As can be appreciated by one of skill in the art after consideration of the present disclosure, the received light 124 will typically have passed through some amount of the atmosphere 148. The received light 124, and in turn the collected light 208, will therefore have been attenuated and altered. This alteration can include the formation of multiple modes, including one or more spatial or polarization modes.

The mode converter 212 divides the received and focused multimode, collected light 208 into a plurality of single mode signals 216a-n. Each of the single mode signals 216a-n is placed on a different single mode optical fiber 220a-n, and passed to a nonlinear optical frequency converter 224.

The nonlinear optical frequency converter 224, which can include a separate input for each of the single mode signals 216a-n, converts the frequency of the individual, single mode signals 216a-n from a first, relatively low frequency, long wavelength at which the collected light 208 was originally emitted as the transmitted optical signal 116, to frequency converted light or optical signals 228a-n having a second, relatively high frequency, shorter wavelength (e.g. less than 1.7 microns). Each of the individual, frequency converted optical signals 228a-n is then passed to a detector 232. In accordance with at least some embodiments of the present disclosure, the wavelength converted signals 228a-n can be passed to the detector 232 across free space.

The detector 232 operates to convert the wavelength converted optical signals 228a-n to one or more electrical signals 236. The detector 232 can include a multiple pixel photodetector, a plurality of single or multiple pixel photodetectors, or a single pixel photodetector. Notably, the detector 232 can include a photodetector having a nominal intrinsic waveband that does not encompass the first frequency of the received light 124, but that does encompass the second frequency of the frequency converted optical signals 228. In accordance with embodiments of the present disclosure, the detector 232 can include, as examples and without limitation, a Geiger mode avalanche photodiode (GmAPD), a single photon avalanche photodiode (SPAD), a charge coupled device, a complementary metal oxide semiconductor (CMOS) image sensor, or an organic photodetector.

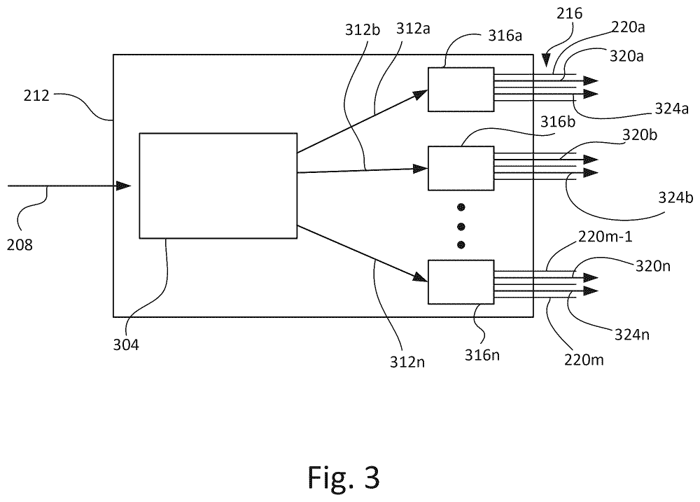

FIG. 3 is a block diagram depicting mode converters 212 of receivers 108 in accordance with at least some embodiments of the present disclosure. In these embodiments, the mode converters 212 include a spatial mode converter 304. The spatial mode converter 304 operates to divide the multimode collected light 208 into a plurality of single spatial mode output signals 312a-n. As examples, and without limitation, the spatial mode converter 304 can include a photonic lantern or a multiplane light converter. The single mode output signals 312a-n are passed to a plurality of polarization mode converters 316a-n. The single mode output signals 312a-n can be carried to the polarization mode converters 316a-n by n single mode fibers. The polarization mode converters 316a-n each operate to produce at least one single mode signal 216. In the example of FIG. 3, the polarization mode converters 316a-n are polarization splitters that convert a spatial mode of a received single spatial mode signal 312 into two single mode signals 216 that include first 320 and second 324 polarization mode output signals. The output signals 320 and 324 of the mode converters 316a-n can each be placed on a different one of m single mode optical fibers 220a-m, where m=2n, for delivery to the nonlinear optical frequency converter 224.

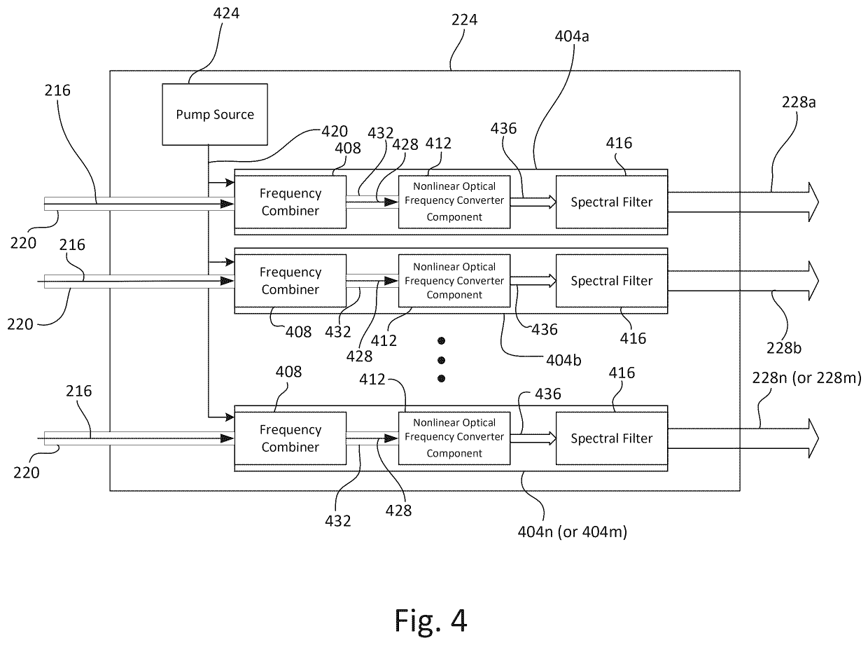

FIG. 4 is a block diagram depicting a nonlinear optical frequency converter 224 of a receiver 108 in accordance with embodiments of the present disclosure. The nonlinear optical frequency converter 224 includes a plurality of nonlinear frequency conversion modules 404 that each receive a single mode signal 216 from the mode converter 212. In particular, when used in connection with a mode converter 212 that produces n first 320 and n second 324 polarization mode output signals, the nonlinear optical frequency converter 224 can include at least 2n nonlinear frequency conversion modules 404a-m. When used in connection with a mode converter 212 that produces n single polarization mode output signals, the nonlinear optical frequency converter 224 can include at least n nonlinear frequency conversion modules 404a-n.

Each nonlinear frequency conversion module 404 can include a frequency combiner 408, a nonlinear optical frequency converter component 412, and a spectral filter 416. Each frequency combiner 408 receives the single mode signal 216 passed to the nonlinear frequency converter module 404 of which the frequency combiner 408 is a part as a first input over an associated single mode optical fiber 220, and a pump optical field or pump signal 420 from a pump source 424 as a second input over a pump source single mode optical fiber. The frequency combiners 408 each operate to place a combined signal 428 that includes the single mode signal 216 received at the first input of the frequency combiner 408 and the pump signal 420 from the pump source 424 onto a single optical fiber 432. In accordance with embodiments of the present disclosure, the frequency combiner 408 can be implemented as a wavelength division multiplexer. As can be appreciated by one of skill in the art after consideration of the present disclosure, the pump signal 420 must be of sufficient optical power to be in the un-depleted pump regime. In accordance with at least some embodiments of the present disclosure, the pump source 424 is a tunable pump laser that allows the receiver 108 acceptance bandwidth to be tuned by changing the wavelength of the pump signal 420.

The combined signal 428 from each frequency combiner 408 is passed to the input of an associated nonlinear optical frequency converter component 412 over a single optical fiber 432. The nonlinear optical frequency converter component 412 can include a nonlinear optical (NLO) crystal waveguide. Each nonlinear optical frequency converter component 412 produces an output signal 436 that includes a number of co-propagating optical fields, such as a frequency converted optical signal, an un-depleted pump signal 420, harmonics of the pump signal 420, and Raman sidebands on the pump signal 420. As can be appreciated by one of skill in the art after consideration of the present disclosure, a nonlinear crystal waveguide implementing a nonlinear optical frequency converter component 412 needs to be of sufficient length to achieve high conversion efficiencies. In accordance with embodiments of the present disclosure, the NLO crystal waveguide phase matching conditions can be tuned by altering the temperature of the waveguide. In accordance with still other embodiments of the present disclosure, each nonlinear frequency conversion module 404 can be tuned to a different acceptance bandwidth to produce frequency converted optical output signals 436 having different nominal wavelengths, to avoid interference between the different nonlinear frequency conversion modules.

The output signal 436 from each nonlinear optical frequency converter component 412 is passed to a spectral filter 416 to remove unwanted signals from the desired frequency converted optical signal. In particular, and as can be appreciated by one of skill in the art after consideration of the present disclosure, the output of a nonlinear optical frequency converter can include, in addition to the frequency converted optical signal, the un-depleted pump signal 420, harmonics of the pump signal 420, and Raman sidebands on the high power pump field. In order to avoid coupling losses, the output signals 436 can be passed to the spectral filter 416 over a free space connection. The spectral filters 416 remove the co-propagating fields having wavelengths other than the selected second wavelength from the output signals 436. In particular, a frequency converted optical output signal 228 for each nonlinear frequency conversion module 404 is separated from the other optical fields and passed to the detector 232. As examples, but without limitation, a spectral filter 416 can include a thin film interference filter, a dispersing prism configured to perform spatial wavelength separation, or a Bragg grating. As an alternative to including one spectral filter 416 for each frequency conversion module 404, one or multiple spectral filters 416 that receive multiple optical output signals 436 can be included.

As can be appreciated by one skilled in the art after consideration of the present disclosure, a majority of the elements in this array of frequency converters depicted in FIG. 4 can be implemented on a monolithic or combined hybrid wafer with structured waveguides, also called an integrated photonic circuits, instead of the assembly of optical fibers and individual components. In particular, a wafer of single crystal Lithium Niobate or another nonlinear optical material can be used where periodically poled ferroelectric domains and waveguide regions are fabricated for the frequency conversion components 412, and on the same wafer passive ridge waveguides are fabricated for the pump source splitters and distribution 420, frequency combiners 408, and spectral filters 416. The interfaces to the input fibers 220 with the single mode light signals 216 from the mode converter 212 can be edge butt coupled, or grating coupled to this monolithic array of waveguides, and the optic fibers 220 can be combined in a fiber ribbon assembly for easier assembly and integration.

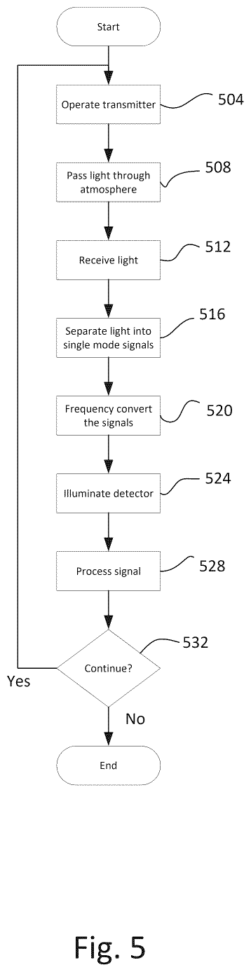

FIG. 5 is a flowchart illustrating aspects of a method of operating a system 104 with a receiver 108 for converting multimode light having a first frequency or wavelength to light having a second frequency or wavelength in accordance with embodiments of the present disclosure. Initially, a transmitter 112 is operated to produce transmitted light 116 (step 504). The transmitted light 116 has a wavelength of 1.7 μm or longer. Where the transmitter 112 is operated as part of a LADAR instrument 114 included in a LADAR system 104a, the transmitted light 116 is directed to a selected volume of the atmosphere or an object 120. Where the transmitter 112 is operated as part of a transmitting system 132 included in a free space optical communication system 104b, the transmitted light 116 is directed to a receiver 108 of a receiving system 136 of the free space optical communication system 104b.

The transmitted light 116 is passed through the atmosphere 148 (step 508), and is received at a receiver 108 as received light 124 (step 512). When operating as part of a LADAR instrument 114, the received light 124 includes transmitted light 116 that has been reflected from the selected volume of the atmosphere or the object 120 and that has passed through the atmosphere 148. In connection with a free space communication system 104b, the received light 124 includes transmitted light 116 that has passed through the atmosphere 148. As can be appreciated by one of skill in the art, the received light 124 can include a plurality of spatial and polarization modes. In particular, even where the transmitted light 116 has a single mode as it leaves the transmitter 112, it will typically be transformed into light having multiple modes as a result of passing through the atmosphere 148.

The received light 124 is then separated into a plurality of single mode signals 216 (step 516). The separation of the received light 124 into a plurality of single mode signals 216 can include passing the received light 124 to an input of a spatial mode converter 304, such as a photonic lantern or a multiplane light converter, to produce a plurality of single mode output signals 312. Each of the single mode output signals 312 from the spatial mode converter can then be separated into first 320 and second 324 polarization mode output signals. As an example, the first 320 and second 324 polarization mode output signals can be formed using polarization splitters 316. Alternatively, each of the single mode output signals 312 from the spatial mode converter can be separated into a plurality of single mode signals 216 in the form of single polarization mode output signals 328. In accordance with embodiments of the present disclosure, the creation of single polarization mode output signals 328 can be performed using polarization controllers or birefringent polarization combiners.

The single mode output signals 216 are then frequency converted (step 520). In particular, the single mode output signals 216 are converted from a first frequency (i.e. the frequency of the transmitted 116 and received 124 light) to a second frequency. The first frequency corresponds to a first wavelength and the second frequency corresponds to a second wavelength, where the first wavelength is longer than the second wavelength. As an example, the first wavelength can be longer than 1.7 μm, and the second frequency can be shorter than 1.7 μm. The frequency conversion can be performed by combining the single mode output signals 216 with a pump signal 420 in a wavelength division multiplexer, to obtain a plurality of combined signals 428, passing the combined signals 428 over an optical fiber 432 to a nonlinear optical frequency converter component 412, such as a nonlinear optical crystal waveguide, and passing an output signal 436 from the nonlinear optical frequency converter component 412 over free space to a spectral filter 416 to obtain frequency converted optical signal outputs 228.

The frequency converted optical signal outputs 228 are then used to illuminate a detector 232 (step 524). An electrical signal or signals 236 produced by the detector 232 can then be processed (step 528). For instance, in connection with a LADAR system 104a, an electrical signal 236 can be processed to determine a range to an object 120 or other characteristics of a volume of the atmosphere or an object 120. As another example, in connection with a communication system 104b, the electrical signal 236 can be processed to extract an encoded message.

A determination can next be made as to whether operation of the system 104 is to continue (step 532). If operation is to continue, the process can return to step 504. Otherwise, the process can end.

Embodiments of the present disclosure therefore provide systems and methods for facilitating or enabling the detection of relatively low frequency, long wavelength (e.g. greater than 1.7 μm) light. For instance, the system can operate to frequency convert and detect transmitted light 116 having a first frequency that passes through some portion of the atmosphere 148 and that arrives at a receiver 108 as received light 124 having the first frequency. The systems can include a lens system 204 that directs the received light 124 having the first frequency and having a plurality of spatial and/or polarization modes to a mode converter 212, such as a photonic lantern. The mode converter 212 divides the received light 124 into a plurality of single mode signals 216. The single mode signals 216 are passed to a nonlinear optical frequency converter 224, which operates to convert the low frequency, long wavelength single mode signals 216 to higher frequency, shorter wavelength (e.g. less than 1.7 μm) signals 228. The frequency converted optical signals 228 are used to illuminate a detector 232, which produces one or more electrical signals 236 from the frequency converted optical signals 228. The electrical signals 236 can be demodulated, for example by a control system 128 or 144 associated with the receiver 108, to extract information about a volume of the atmosphere or an object 120 (where the system is operated as a LADAR system 104a), or to extract an information signal (where the system is operated as a communication system 104b).

In accordance with embodiments of the present disclosure, the frequency converted output signal 228 has a wavelength of less than 1.7 μm. As a result of the frequency conversion, the relatively short wavelength output signal 228 can be efficiently converted to one or more electrical output signals 236 by a detector 232. In particular, the conversion process described herein, for instance implemented by a receiver 108 configured in accordance with embodiments of the present disclosure, allows the use of detectors 232 capable of efficiently detecting light at wavelengths that encompass the wavelength of the frequency converted output signal 228 (e.g. less than 1.7 μm). Such detectors 232 can be obtained more readily, and at lower cost, than detectors that would be required to convert light at the original frequency or wavelength of the transmitted signal 116. Other advantages of such detectors 232 can include greater detection efficiency, greater reliability, and greater accuracy.

Although various examples of systems 104 have been discussed herein, it should be appreciated that a receiver 108 as disclosed herein has application in other systems or scenarios. For instance, although an example of a LADAR system 104a in which a transmitter 112 and a receiver 108 are co-located has been discussed, a receiver 108 as disclosed herein can be operated as part of a LADAR system in which the transmitter 112 is at some distance from the receiver 108. As another example, LADAR and communication systems 104 as disclosed herein can utilize transmitted signals 116 that consist of a single mode or multiple modes as they leave the transmitter 112. Moreover, a receiver 108 as disclosed herein is not limited to use with LADAR or communication systems. Instead, a receiver 108 as disclosed can be used to efficiently convert any relatively low frequency, long wavelength, multimode optical signal to a higher frequency, shorter wavelength signal. Accordingly, receiver 108 systems and methods as disclosed herein can facilitate the efficient detection of any optical signals that are received as relatively low frequency, multimode signals.

The foregoing description has been presented for purposes of illustration and description. Further, the description is not intended to limit the disclosed systems and methods to the forms disclosed herein. Consequently, variations and modifications commensurate with the above teachings, within the skill or knowledge of the relevant art, are within the scope of the present disclosure. The embodiments described hereinabove are further intended to explain the best mode presently known of practicing the disclosed systems and methods, and to enable others skilled in the art to utilize the disclosed systems and methods in such or in other embodiments and with various modifications required by the particular application or use. It is intended that the appended claims be construed to include alternative embodiments to the extent permitted by the prior art.

What is claimed is:

1. A system, comprising:
a mode converter, wherein a multimode optical signal having a first frequency is received at the mode converter, and wherein the mode converter converts the received multimode optical signal into a plurality of single mode signals; and
a nonlinear optical frequency converter, wherein at least one of the single mode signals output from the mode converter is received by the nonlinear optical frequency converter, and wherein the nonlinear optical frequency converter converts the at least one received single mode signal into at least one frequency converted optical signal.

2. The system of claim 1, further comprising:
a detector, wherein the at least one frequency converted optical signal is output from the nonlinear frequency converter to the detector.

3. The system of claim 1, further comprising:
receive optics, wherein the receive optics focus the multimode optical signal having a first frequency onto an input of the mode converter.

4. The system of claim 1, further comprising:
at least one single mode optical fiber, wherein the at least one single mode optical fiber connects an output of the mode converter to an input of the nonlinear optical frequency converter.

5. The system of claim 1, wherein the nonlinear optical frequency converter includes:
a light source; and
at least one frequency combiner, wherein the at least one frequency combiner receives a single spatial and polarization mode output from the mode converter and a pump signal from the light source, and wherein each frequency combiner outputs a combined signal.

6. The system of claim 5, wherein the nonlinear optical frequency converter further includes:
at least one nonlinear optical frequency converter component, wherein the at least one nonlinear optical frequency converter component receives a combined signal from the at least one frequency combiner, and wherein the at least one nonlinear optical frequency converter component outputs a frequency converted signal.

7. The system of claim 6, wherein the at least one nonlinear optical frequency converter component is a nonlinear optical crystal waveguide.

8. The system of claim 6, wherein the nonlinear optical frequency converter further includes:
at least one filter, wherein the at least one filter receives a frequency converted signal from the at least one nonlinear optical frequency converter component, and wherein the at least one filter removes frequencies different than a selected second frequency and outputs a frequency converted output signal.

9. The system of claim 8, wherein the combined signal is passed to the at least one nonlinear optical frequency converter over at least one optical fiber, and wherein the frequency converted signal is passed to the at least one filter over free space.

10. The system of claim 2, wherein the detector is one of:
a multiple pixel optical detector;
a single pixel optical detector; or
a plurality of single pixel optical detectors.

11. A method, comprising:
receiving a multimode optical signal at a receiver;
converting the multimode optical signal into at least one single mode optical signal; and
converting a frequency of the at least one single mode optical signal from a received frequency to a converted frequency.

12. The method of claim 11, wherein the received frequency is lower than the converted frequency.

13. The method of claim 11, wherein receiving a multimode optical signal at the receiver includes receiving an optical signal having plurality of spatial and polarization modes at the receiver.

14. The method of claim 13, outputting at least one single mode optical signal with the converted frequency.

15. The method of claim 14, further comprising:
detecting the at least one single mode optical signal with the converted frequency at a detector.

16. The method of claim 11, detecting the at least one frequency converted single mode optical signal using a multiple pixel detector.

17. The method of claim 11, wherein the multimode optical signal received at the receiver has a first frequency associated with a first wavelength, wherein the at least one single mode optical signal has the first frequency, wherein the at least one single mode optical signal having the first frequency is converted to a second frequency associated with a second wavelength, wherein the first wavelength is longer than 1.7 μm, and wherein the second wavelength is shorter than 1.7 μm.

18. An optical signal detection system, comprising:
a transmitter, wherein the transmitter transmits light at a first frequency;
receive optics, wherein the receive optics receive light transmitted from the transmitter and having the first frequency and at least one mode;
a receiver, wherein the receive optics direct at least some of the light transmitted by the receiver and having the first frequency and the at least one mode to the receiver, the receiver including:
a mode converter, wherein the mode converter converts the light having the first frequency and the at least one mode to at least one optical signal having the first frequency and a single mode; and
a nonlinear optical frequency converter, wherein the nonlinear optical frequency converter converts the at least one optical signal having the first frequency and a single mode to light at least one optical signal having a second frequency; and
a detector, wherein the detector converts the at least one optical signal having the second frequency to one or more electrical signals.

19. The optical signal detection system of claim 18, wherein the nonlinear optical frequency converter includes at least one nonlinear frequency conversion modules.

20. The optical detection system of claim 18, wherein the first frequency is associated with a wavelength of greater than 1.7 μm, and wherein the second frequency is associated with a wavelength of less than 1.7 μm.
